(19) United States
(12) Patent Application Publication
(10) Pub. No.: US 2006/0187972 A1
(43) Pub. Date: Aug. 24, 2006

(54) Core network system and optical transmission equipment

(75) Inventors: Yoshiaki Aono, Tokyo (JP); Akira Kobayashi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/328,228

(22) Filed: Jan. 10, 2006

(30) Foreign Application Priority Data
Jan. 21, 2005 (JP) 2005-013451

(51) Int. Cl. H04J 3/04

(52) U.S. Cl. 370/535

(57) ABSTRACT

Disclosed is a core network system which performs bi-directional optical transmission, including: a first transmission path for transmitting an optical signal, which is wavelength division-multiplexed, toward subscriber terminals from the core network; and a second transmission path for transmitting an optical signal, which is wavelength division-multiplexed, from the subscriber terminals to the core network; wherein transmission capacity of the second transmission path is lessen rather than transmission capacity of the first transmission path in agreement with asymmetry of traffic of the second transmission path to the first transmission path. Further, optical transmission equipment which constructs the core network system is also disclosed.

### BACKGROUND OF THE INVENTION

1. Field of the Invention

The present invention relates to a core network system and optical transmission equipment, and in particular, to a core network system and optical transmission equipment which are used for optical network infrastructure construction which a telecommunications carrier, called “a carrier”, or the like builds.

2. Description of the Related Art

A network of a carrier is constructed of an access network which connects a user and a nearby telecommunication office, and a core network which connects between respective telecommunication offices. A shift to a broadband by high-speed ADSL (Asymmetric Digital Subscriber Line) and FTTH (Fiber To The Home) in these networks enable large capacity data transmission. As a result, a user can utilize a phone, the Internet, Digital Video service using one communication line. The buildup of traffic by such shift to a broadband makes it necessary to reinforce the core network which is a backbone.

Generally, an optical transmission core network is constructed of WDM (Wavelength Division Multiplexing) equipment and an L2 switch (Layer 2 Switch). The L2 switch has a function of assigning a transmission direction of traffic. The WDM equipment has a function of transmitting the traffic assigned by the L2 switch. In order to make transmission capacity increase, it is necessary to extend both of the L2 switch and the WDM equipment. An example of such WDM equipment is disclosed in U.S. Patent Application Publication No. US2003/0147585A1.

In conventional core networks, since images and music data flow through the networks, increase of traffic is caused. In comparison with data capacity to be required, although telephone communication is several k bps, transmission of an image or music data is tens Mbps, which is incommensurable capacity.

In addition, a user exchanges neither an image nor music data in two-ways, but they are distributed toward a user from a certain fixed place (contents holder). In this case, as for the traffic capacity, large volume of images and music data flow in a direction to a user from a contents holder (downlink direction), but a control signal and the like which do not require large capacity flow in its reverse direction (uplink direction).

With paying attention to this asymmetry, in conventional core network equipments having uplink/downlink transmission path integrated-type hardware configuration, since the simultaneous investment of uplink/downlink transmission path becomes necessary according to a peak value even if the traffic in only one direction (for example, downlink transmission path) increases, the investment more than needed becomes necessary in the uplink transmission path.

Furthermore, in conventional WDM products, even if traffic volume increases asymmetrically in the uplink and downlink directions since transponders have transmission/reception integrated-type construction, it is necessary to perform the same amounts of capital investments in both directions. As a result, it may arise that the capital investments do not always become economical according to the traffic capacity. Thus, in the conventional core networks, since it is necessary to perform bi-directional symmetrical capital investments regardless of the asymmetry of traffic, useless investments have arisen.

### SUMMARY OF THE INVENTION

In view of such problems, the present invention was performed.

An exemplary feature of the present invention is to provide a core network system and optical transmission equipment which can overcome the above-mentioned problems and can correspond to the buildup of traffic without useless or unnecessary investment.

The present invention provides a core network system which performs bi-directional optical transmission, including: a first transmission path for transmitting an optical signal, which is wavelength division-multiplexed, toward subscriber terminals from the core network; and a second transmission path for transmitting an optical signal, which is wavelength division-multiplexed, from the subscriber terminals to the core network; wherein transmission capacity of the second transmission path is lessen rather than transmission capacity of the first transmission path in agreement with asymmetry of traffic of the second transmission path to the first transmission path.

Further, the present invention provides optical transmission equipment which constructs a core network system which performs bi-directional optical transmission, including: a plurality of first transponders provided in a first transmission path for transmitting an optical signal, which is wavelength division-multiplexed, toward subscriber terminals from the core network; and a plurality of second transponders provided in a second transmission path for transmitting an optical signal, which is wavelength division-multiplexed, from the subscriber terminals to the core network; wherein transmission capacity of the second transmission path is smaller than transmission capacity of the first transmission path in agreement with asymmetry of traffic of the second transmission path to the first transmission path.

Adoption of such construction described in the present invention makes it possible to obtain an effect that it is possible to correspond to the asymmetric traffic buildup in a core network without causing the generation of a useless investment.

### BRIEF DESCRIPTION OF THE DRAWINGS

The above and other exemplary aspects, features and advantages of the present invention will become more apparent from the following detailed description when taken in conjunction with the accompanying drawings wherein:

FIG. 1 is a block diagram showing the entire construction of a core network system according to exemplary embodiments of the present invention;

FIG. 2 is a block diagram showing the construction of a telecommunication office (optical transmission equipment) according to a first exemplary embodiment of the present invention;

FIG. 3 is a block diagram showing the construction of a telecommunication office (optical transmission equipment) according to a second exemplary embodiment of the present invention; and

FIG. 4 is a block diagram showing the construction of a telecommunication office (optical transmission equipment) according to a third exemplary embodiment of the present invention.

### DETAILED DESCRIPTION OF THE EXEMPLARY EMBODIMENTS

Exemplary embodiments of the present invention will now be described in detail in accordance with the accompanying drawings.

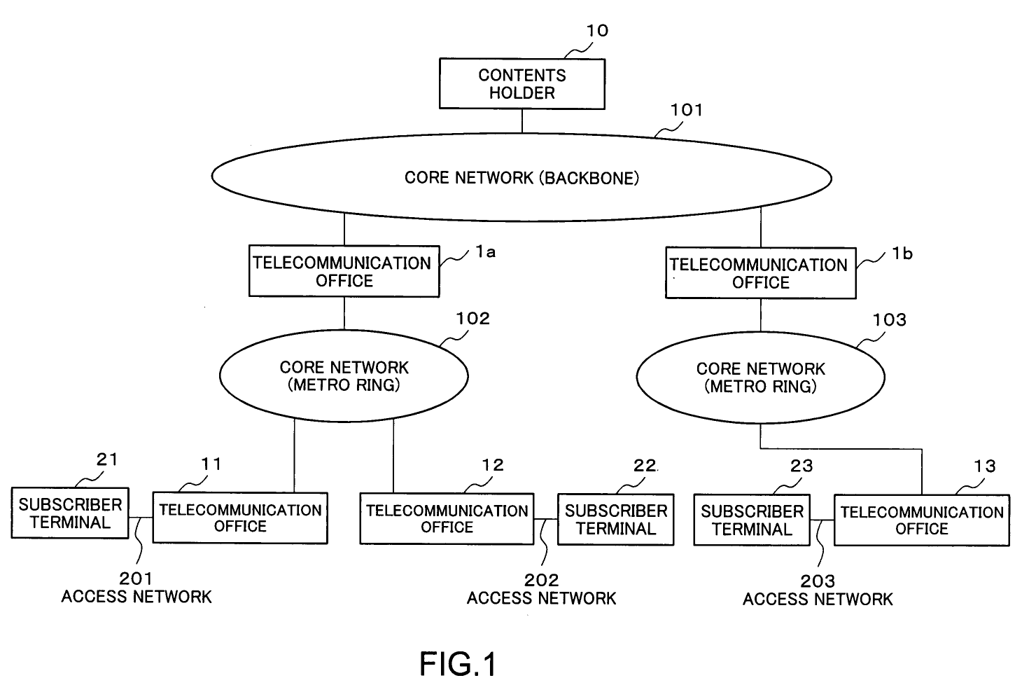

FIG. 1 is a block diagram showing the entire construction of a core network system according to exemplary embodiments of the present invention.

In the core network system shown in FIG. 1, a core network (backbone) 101 and core networks (a metro ring(s) or a metro network(s)) 102 and 103 are connected through telecommunication offices 1a and 1b. Furthermore, an information server installed by a contents holder 10 which distributes image data and music data toward users is connected to the core network 101. Furthermore, the telecommunication offices 11 and 12 are connected to the core network 102. The telecommunication office 11 accommodates' and connects a subscriber terminal 21 through an access network 201. The telecommunication office 12 accommodates and connects a subscriber terminal 22 through an access network 202. On the other hand, the telecommunication office 13 is connected to the core network 103. The telecommunication office 13 accommodates and connects a subscriber terminal 23 through an access network 203. In addition, although a plurality of subscriber terminals are usually connected to each of the telecommunication offices 11 to 13, one is illustrated every telecommunication office in FIG. 1 for simple description.

In the embodiments of the present invention, the core networks 101 to 103 are at least high-speed optical transmission networks which each transmit a WDM signal. Therefore, each telecommunication office is constructed of optical transmission equipment as mentioned later. In addition, the low-speed access networks 201 to 203 may be also communication networks of optical signals, or communication networks of electrical signals.

In the embodiments of the present invention, it is supposed that the core networks 101, 102, and 103 do not have the same transmission capacities in both directions (up/down) but are asymmetrical according to the asymmetry of traffic. This technology is applicable to a backbone or a metro network in a core network.

As mentioned above, in order to make traffic in core networks 101, 102, and 103 asymmetrical, what are performed in the telecommunication offices 11 to 13 in the embodiment of the present invention are: (1) reduction of E/O (Electric/optical) converter modules by port aggregation of transponders on the uplink transmission path, (2) speed control in transponders on the uplink transmission path, and (3) reduction of transponders on the uplink transmission path by port aggregation of an L2 switch (Layer 2 Switch). That is, what corresponds as respective means for making transmission capacity of the uplink transmission path smaller than that of the downlink transmission path according to the asymmetry of traffic are: (1) a multiplexer which multiplexes signals, which should be transmitted to the core network uplink transmission path, in a state of electrical signals within an uplink transponder, (2) a speed converter which makes a signal, which should be transmitted to the core network uplink transmission path, changed to a low speed, in a state of an electrical signal in the uplink transponder, and (3) an L2 switch which aggregates output ports to the uplink transponder. In addition, it is also possible to use each of these construction and methods independently, or to use them in combination.

### First Exemplary Embodiment

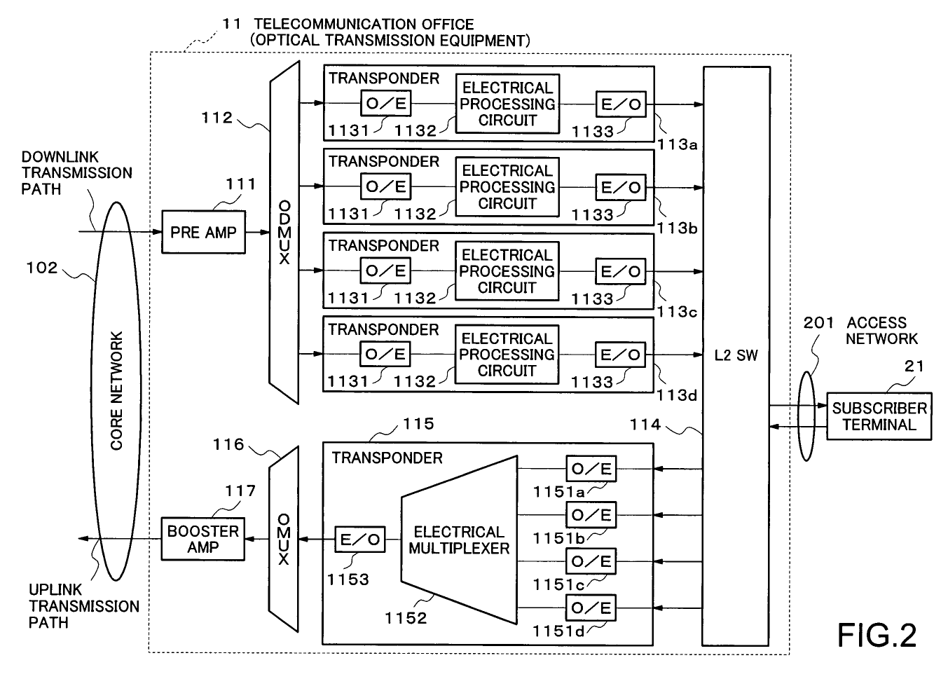

FIG. 2 is a block diagram showing the construction of a telecommunication office (optical transmission equipment) according to a first exemplary embodiment of the present invention. This telecommunication office is connected to a core network and further connects to a subscriber terminal through an access network. Although the telecommunication office 11 is explained as an example in FIG. 2, this construction is applicable to other telecommunication offices 12, 13, and the like.

The telecommunication office (optical transmission equipment) 11 is constructed of a preamplifier (pre AMP) 111, an ODMUX (Optical Demultiplexer) 112, downlink transponders 113a to 113d, an uplink transponder 115, an L2 switch (Layer 2 Switch) 114, an OMUX (Optical Multiplexer) 116, and booster amplifier 117. In addition, in FIG. 2, for simple explanation, four (4) downlink transponders and one (1) uplink transponder are exemplified and shown. Nevertheless, the quantity of transponders is not limited to this.

The transponder 113a in the downlink transmission path side of the core network 102 is constructed of an optical/electric (O/E) converter 1131, an electrical processing circuit (or unit). 1132, and an electric/optical (E/O) converter 1133. Other downlink transponders 113b to 113d have the same construction. The transponder 115 in the uplink transmission path side of the core network 102 is constructed of optical electric (O/E) converters 1151a to 1151d, an electrical multiplexer 1152, and an electric/optical (E/O) converter 1153. In addition, the number of the O/E converters 1151a to 1151d is not limited to four (4).

A WDM optical signal sent through the downlink transmission path of the core network 102 is amplified by the preamplifier 111. This amplified signal is split into optical signals at respective wavelengths which construct a WDM signal in the ODMUX 112, and the optical signals are inputted into the downlink transponders 113a to 113d corresponding to respective wavelengths.

Each of the transponders 113a to 113d converts the optical signal from the ODMUX 112 into an electrical signal in the O/E converter 1131, and outputs it to the electrical processing circuit 1132. The electrical processing circuit 1132 processes the electrical signal from the O/E converter 1131 (e.g., error correction processing), and outputs the processed electrical signal to the E/O converter 1133. The E/O converter 1133 converts the electrical signal from the electrical processing circuit 1132 into the optical signal at a desired wavelength, and outputs it to the L2 switch 114.

The L2 switch 114 performs packet routing according to layer 2 processing, and sends the signal (signal corresponding to the subscriber terminal 21) from the E/O converter 1133 to the subscriber terminal 21 through the access network 201. The L2 switch performs O/E conversion or E/O conversion if needed. Therefore, optical transmission or electrical signal transmission can be adopted in the access network (low speed) In addition, although not shown in FIG. 2, the L2 switch accommodates and connects a plurality of subscriber terminals actually.

Next, signal transmission operation in the uplink direction will be explained. First, the subscriber terminal 21 transmits a signal (e.g., an optical packet signal) to an input port of the L2 switch 114 through the access network 201. When recognizing that it is a signal from the subscriber terminal 21, the L2 switch 114 outputs the signal to an output port to the transponder 115. Optical signals from other subscriber terminals which are not shown are also similarly inputted into the transponder 115 by the L2 switch 114.

In the transponder 115, the O/E converters 1151a to 1151d convert a plurality of optical signals from the L2 switch 114 into electrical signals respectively, and send them to the electrical multiplexer 1152. While processing the electrical signals from the respective O/E converters 1151a to 1151d (e.g. error correction processing etc.), the electrical multiplexer 1152 performs electrical multiplexing and sends the multiplexed signal to the E/O converter 1153. The E/O converter 1153 converts the electrical multiplexed signal from the electrical multiplexer 152 into an optical signal of a one-wavelength WDM signal, and sends it to the OMUX 116.

Since a plurality of transponders 115 exist actually (a lot of subscriber terminals exist), respective optical signals from these transponders 115 are multiplexed by the OMUX 116, and are made a WDM optical signal. This WDM optical signal is amplified by the booster amplifier 117, and is outputted to the uplink transmission path of the core network 102.

The electrical multiplexer 1152 may be, for example, a time-division multiplexing type multiplexer. Alternatively, it may be a multiplexer of performing operation like statistical multiplexing depending on a circuit or device which achieves a layer 2 multiplexing function which aggregates and outputs four (4) ports of packet inputs into one (1) port. Since the electrical multiplexer 1152 aggregates four (4) ports of outputs of the L2 switch 114 into one (1), only one E/O converter 1153 is sufficient.

Thus, in this embodiment, since the transponder 115 outputs a signal to the uplink transmission path of the core network 102 after performing electrical multiplexing in the electrical multiplexer 1152, it is possible to decrease the number of the expensive E/O converters 1153 for high-speed transmission in the uplink transponder 115 to save cost.

For example, since the electrical multiplexer 1152 multiplexes the four (4) uplink signals in this embodiment, the number of E/b converters in the uplink transponder becomes ¼ of that in the conventional construction.

Here, a specific example of transmission capacity (transmission speed×signal number) will be described. It is more suitable to regard traffic as asymmetrical in order to contain various services under a broadband environment. According to guessing traffic on the basis of contents of service use, and the asymmetry (about ⅛ to 1/32) of an uplink transmission path to an downlink transmission path of ADSL (Asymmetric Digital Subscriber Line) or FTTH (Fiber To The Home) which has generally spread, the asymmetry of the uplink transmission path to the downlink transmission path of the traffic which flows through the core network is guessed to be about 26% or less.

Then, in this embodiment, let a downlink transmission path be 400 Gbps (=10 Gbps×40 wavelengths) and let an uplink transmission path be 100 Gbps which is 26% of 400 Gbps (≈400 Gbps×26%), and the uplink transmission path becomes 10 Gbps×10 wavelengths, and hence, it is not necessary to let it be 40 wavelengths similarly to the downlink transmission path. That is, in this case, although forty (40) downlink transponders 113a, 113b . . . are required, only ten (10) uplink transponders 115 are required.

In addition, let a downlink transmission path be 400 Gbps (=10 Gbps×40 wavelengths) and let an uplink transmission path be 40 Gbps (=400 Gbps/10) which is 1/10 of 400 Gbps, and the uplink transmission path becomes 10 Gbps×4 wavelengths (four (4) uplink transponders). In addition, this embodiment can also correspond to the case that an uplink transmission path is made 1/n (n is a number of two or more, and optimally a number of four or more) of a downlink transmission path.

Hence, in this embodiment, because of making the transmission capacity of a conventional symmetric core network asymmetric in agreement with asymmetry of traffic to make transponders, used for the core network, the construction as mentioned above, it is possible to reduce the number of expensive E/O converters of a transponder in an uplink transmission path side.

As explained above, in this embodiment, by multiplexing electrical signals in the transponder in the uplink direction, it is possible to decrease the number of hardware of expensive E/O converters to save cost.

### Second Exemplary Embodiment

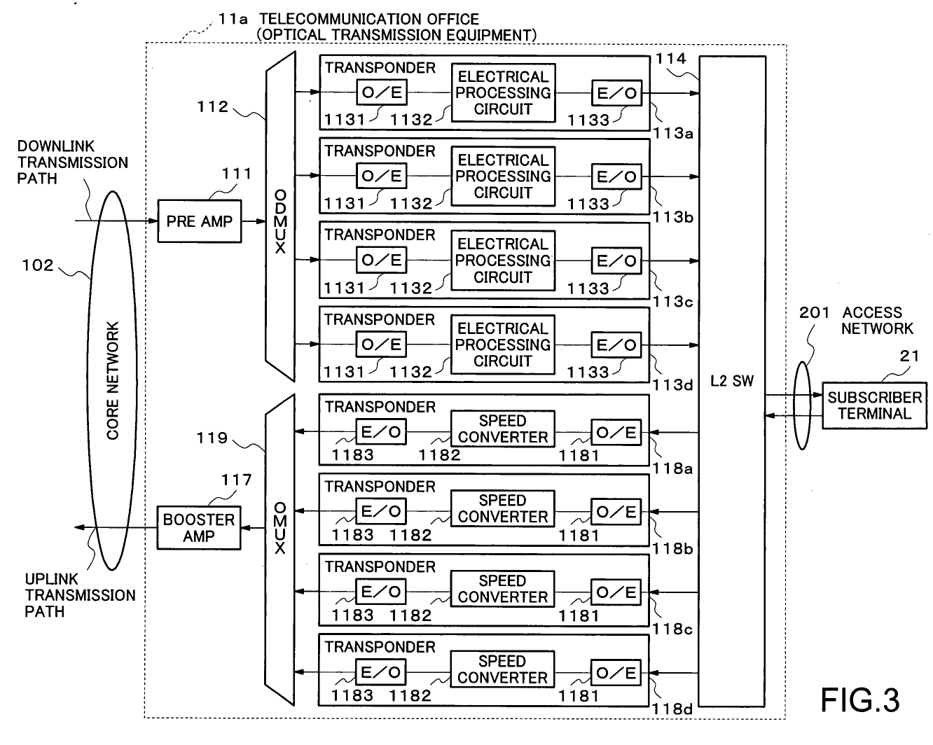

FIG. 3 is a block diagram showing the construction of a telecommunication office (optical transmission equipment) according to a second exemplary embodiment of the present invention. In comparison with the telecommunication office 11 in FIG. 2, in a telecommunication office 11a of FIG. 3, the uplink transponder 115 (FIG. 2) is changed to uplink transponders 118a to 118d (FIG. 3), and further, the OMUX 116 (FIG. 2) is changed to an OMUX 119 (FIG. 3). The transponders 118a to 118d can adjust signal transmission speed. The OMUX 119 multiplexes optical signals (also including those signals, when there are other transponders which are not shown) from the transponders 118a to 118d. Except them, the telecommunication office 11a has the same construction as that of the telecommunication office 11 according to the first exemplary embodiment of the present invention shown in FIG. 2, and the same reference symbols are assigned to the same constituents. In addition, operation of the same constituents is the same as that of the above-mentioned first exemplary embodiment. Furthermore, in FIG. 3, for simple explanation, an example of the case of four (4) transponders is shown.

Each of the transponders 118a to 118d is constructed of an O/E converter 1181, a speed converter 1182 and an E/O converter 1183. The speed converter 1182 adjusts a signal transmission speed (deceleration) by deleting an idle pattern or performing bandwidth control by backpressure to a signal from the L2 switch 114.

With reference to FIG. 3, operation in an uplink transmission path side of the core network 102 in the telecommunication office 11a according to the second exemplary embodiment of the present invention will be described. In addition, since operation in a downlink transmission path side of the core network 102 in the telecommunication office 11a is the same as that in the above-mentioned first exemplary embodiment of the present invention, its description is omitted.

The subscriber terminal 21 transmits a signal (e.g., an optical packet signal) to an input port of the L2 switch 114 through the access network 201. When recognizing that it is a signal from the subscriber terminal 21, the L2 switch 114 outputs the signal to an output port to the transponder 118a. Optical signals from other subscriber terminals which are not shown are also similarly inputted into any of the transponders 118a to 118d by the L2 switch 114.

In respective transponders 118a to 118d, the O/E converters 1181 convert a plurality of optical signals from the L2 switch 114 into electrical signals, and send them to the speed converter 1182. While processing the electrical signal from the O/E converter 1181 (e.g., error correction processing or the like), the speed converter 1182 performs speed conversion (deletion of an idle pattern, or bandwidth control by back pressure) to send it to the E/O converter 1183. The E/O converter 1183 converts the electrical signal which is given speed conversion by the speed converter 1182 into an optical signal of a one-wavelength WDM signal, and sends it to the OMUX 119. The optical signals from the transponders 118a to 118d are multiplexed by an OMUX 119 to be made a WDM signal, and the WDM signal is amplified by the booster amplifier 117 to be outputted to the uplink transmission path of the core network 102.

Here, the idle pattern deletion in the speed converter 1182 is exemplified for transmission signal speed conversion to be explained. Actual traffic (information to be transmitted) and idle patterns flow in the uplink transmission path of the symmetric and bi-directional core network similarly to the downlink transmission path. However, in the uplink transmission path, since actual traffic decreases, a rate of unnecessary idle patterns increases. Therefore, in the speed converter 1182, it is possible to lessen uplink transmission path capacity (to lower a transmission speed) by deletion of idle patterns (these are inserted in order to always keep transmission speed constant) unnecessary for information transmission. Moreover, the bandwidth control by backpressure means outputting a pause signal from an uplink transponder to the L2 switch to suppress the corresponding output port of the L2 switch temporarily. That is, even if the deletion of idle patterns is performed as mentioned above, when there is much actual traffic, it is not possible to reduce a transmission speed fully. A countermeasure to that case is to make a signal input from the L2 switch paused temporarily.

Thus, in this embodiment, since the transponders 118a to 118d output signals to the uplink transmission path of the core network 102 after making transmission speed into a low speed, it is possible to aim at cost reduction of the E/O converter modules 1183. For example, when it is possible to change modules to those corresponding to 1 Gbps from those corresponding to 10 Gbps by performing speed control in the transponders 118a to 118d in the uplink transmission path side, it is possible to aim at cost reduction of modules. Furthermore, in that case, since the uplink transmission path is 1-Gbps WDM transmission, dispersion compensation becomes unnecessary.

Here, a specific example of transmission capacity (transmission speed×signal number) will be described. In this embodiment, let the downlink transmission path be 400 Gbps (=10 Gbps×40 wavelengths) and let the uplink transmission path be 100 Gbps which is 26% of 400 Gbps (≈400 Gbps×26%), and the uplink transmission path becomes 2.5 Gbps×40 wavelengths. Therefore, since it is not necessary to use 10-Gbps corresponding articles or products like those in the downlink transmission path, more inexpensive 2.5-Gbps corresponding modules may be used. The reason for making the uplink transmission path into 26% of the downlink transmission path is the same as the description in the first exemplary embodiment of the present invention.

In addition, with letting the downlink transmission path be 400 Gbps (=10 Gbps×40 wavelengths) and letting the uplink transmission path be 40 Gbps (=400 Gbps/10) which is 1/10 of 400 Gbps, the uplink transmission path becomes 1 Gbps×40 wavelengths, and it becomes possible to use E/O converter modules corresponding to 1 Gbps. This embodiment can also correspond to the case that an uplink transmission path is made 1/n (n is a number of four or more, and optimally a number of ten or more) of a downlink transmission path.

Hence, in this embodiment, because of making an conventional symmetric core network asymmetric in agreement with asymmetry of traffic to make transponders, used for the core network, the construction as mentioned above, it is possible to use inexpensive low-speed E/O converters. Furthermore, it is possible to obtain an effect that dispersion compensation becomes unnecessary by fully lowering the transmission capacity of the uplink transmission path.

### Third Exemplary Embodiment

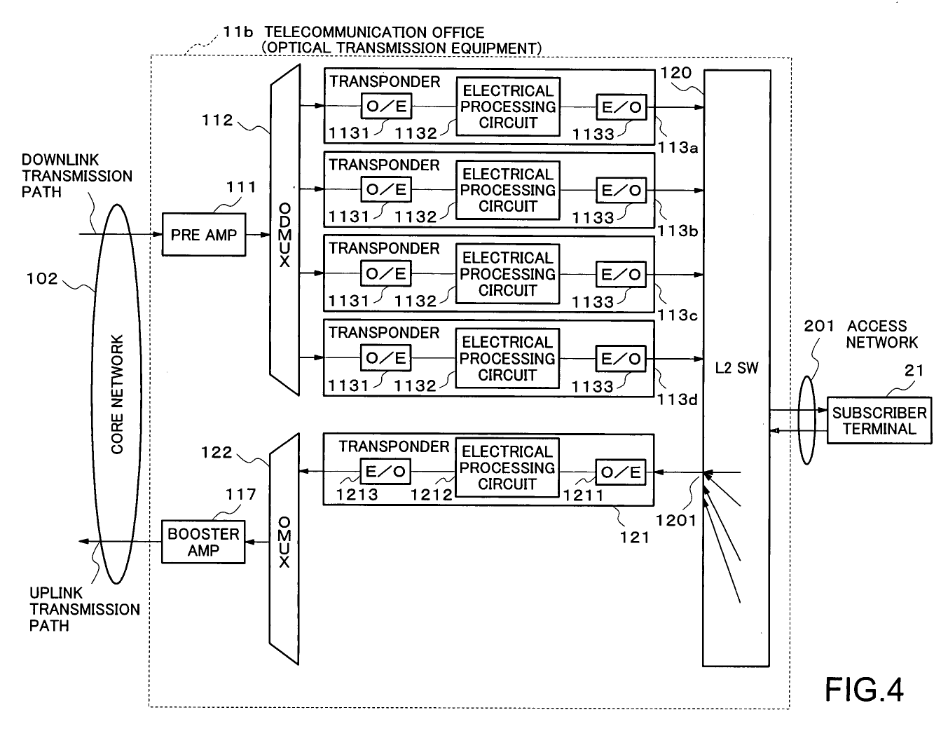

FIG. 4 is a block diagram showing the construction of a telecommunication office (optical transmission equipment) according to a third exemplary embodiment of the present invention. In comparison with the telecommunication office 11 of FIG. 2, in the telecommunication office 11b of FIG. 4, the L2 switch 114, transponder 115 and OMUX 116 (FIG. 2) are changed to an L2 switch 120, a transponder 121 and an OMUX 122 (FIG. 4), respectively. The L2 switch 120 can aggregate ports in an output port by its routing function. In this embodiment, four (4) input ports of the L2 switch 120 are outputted to one (1) output port 1201. The number of uplink transponders 121 is provided according to the number of aggregated out ports of the L2 switch. The OMUX 122 multiplexes optical signal outputs of respective transponders 121 also including those not shown.

Except them, the telecommunication office 11b has the same construction as that of the telecommunication office 11 according to the first exemplary embodiment shown in FIG. 2, and the same reference symbols are assigned to the same constituents. In addition, operation of the same constituents is the same as that in the above-mentioned first exemplary embodiment. In addition, in FIG. 4, for simple explanation, an example of the case of four (4) transponders is shown.

The transponder 121 is constructed of an O/E converter 1211, an electrical circuit 1212 and an E/O converter 1213. The L2 switch 120 aggregates signals of four (4) input ports into one (1) output port in its inside, and outputs it to the transponder 121.

With reference to FIG. 4, operation in an uplink transmission path side of the core network 102 in the telecommunication office 11b according to the third exemplary embodiment of the present invention will be described. Since operation in a downlink transmission path side of the core network 102 in the telecommunication office 11b is the same as that in the above-mentioned first exemplary embodiment, its description is omitted.

The subscriber terminal 21 transmits a signal (e.g., an optical packet signal) to an input port of the L2 switch 120 through the access network 201. When recognizing that it is a signal from the subscriber terminal 21, the L2 switch 120 outputs the signal to the output port 1201 to the transponder 121. Signals from other subscriber terminals which are not shown are also similarly outputted to the output port 1201 to the transponders 121 by the L2 switch 120, and consequently, signals of four (4) input ports are aggregated into one (1) output port in the L2 switch 120.

In the transponder 121, the O/E converter 1211 converts an optical signal from the L2 switch 120 into an electrical signal, and sends it to the electrical processing circuit 1212. The electrical processing circuit 1212 processes the electrical signal from the O/E converter 1211 (e.g., error correction processing), and outputs the signal to the E/O converter 1213. The E/O converter 1213 converts the signal which is processed by the electrical processing circuit 1212 into an optical signal, and sends it to the OMUX 122.

The optical signals from respective transponders also including those not shown are multiplexed by the OMUX 122 to be made a WDM signal, and the WDM signal is amplified by the booster amplifier 117 to be outputted to the uplink transmission path of the core network 102.

Thus, in this embodiment, since the L2 switch 120 aggregates a plurality of input ports from the access network 201 into one output port to output it to each transponder 121, it is possible to save the number of hardware of the transponders in the uplink transmission path. For example, in the embodiment of the present invention, although four (4) uplink transponders are originally required, just one (1) uplink transponder can perform this role by the port aggregation of the L2 switch. In this case, in a communication system of the present invention, an electrical multiplexer becomes unnecessary in comparison with the case (FIG. 2) that port aggregation is performed within an uplink transponder.

Here, a specific example of transmission capacity (transmission speed×signal number) will be described. In this embodiment, let the downlink transmission path be 400 Gbps (=10×Gbps×4 wavelengths) and let the uplink transmission path be 100 Gbps which is 26% of 400 Gbps (≈400 Gbps×26%), and the uplink transmission path becomes 10 Gbps×10 wavelengths. Therefore, since it is possible to make the number of transponders ¼ of that in a downlink transmission path, it becomes possible to reduce the number of the expensive high-speed E/O converters 1213, and hence, it is possible to save cost. The reason for making the uplink transmission path into 26% of the downlink transmission path is the same as the description in the first exemplary embodiment.

In addition, let a downlink transmission path be 400 Gbps (=10 Gbps×40 wavelengths) and let an uplink transmission path be 40 Gbps (≈400 Gbps/10) which is 1/10 of 400 Gbps, and the uplink transmission path becomes 10 Gbps×4 wavelengths, and hence, the number of transponders is sufficient by 1/10 of that in the downlink transmission path. This embodiment can also correspond to the case that an uplink transmission path is made 1/n (n is a number of two or more) of a downlink transmission path.

Hence, in this embodiment, because of making an conventional symmetric core network asymmetric in agreement with asymmetry of traffic to make transponders, used for the core network, the construction as mentioned above, it is possible to reduce transponders themselves in the uplink transmission path and to reduce the number of expensive E/O converters. In addition, an electrical multiplexer inside the uplink transponder also becomes unnecessary in comparison with the first exemplary embodiment.

Furthermore, in the present invention, it is also possible to combine and perform respective exemplary embodiments mentioned above. For example, there is a possibility of further enlarge a cost reduction merit by combining the speed conversion (deceleration) shown in FIG. 3 with signal multiplexing (reduction of numbers of signals and channels) shown in FIG. 2 or 4. This is because it is possible to reduce the number of the E/O converters themselves or the number of the transponders themselves by signal multiplexing while it is possible to use low-speed modules for E/O converter modules by speed conversion to make dispersion compensation unnecessary.

For example, a100-Gbps (=5 Gbps×20 wavelengths) uplink transmission path to a 400-Gbps (=10 Gbps×40 wavelengths) downlink transmission path has a larger cost reduction merit in total than the case of only the signal multiplexing in a 10 Gbps×10 wavelength uplink transmission path, or the case of only the speed conversion in a 2.5 Gbps×40 wavelength uplink transmission path.

In addition, although each exemplary embodiment of the present invention mentioned above is described in the case of 4:1 that four (4) downlink transponders are aggregated into one (1) uplink transponder, this is just exemplification merely. For example, when there are five (5) downlink transponders, it is also possible to aggregate the uplink transponders into one (1). Alternatively, when there are seven (7) downlink transponders, it is also possible to divide those transponders into sets of four (4) and three (3) to aggregate each set into one (1) corresponding uplink transponder. That is, it is possible to set the combination freely, and these combinations are not limited to the above-mentioned respective embodiments.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

Further, it is the inventor's intention to retain all equivalents of the claimed invention even if the claims are amended during prosecution.

What is claimed is:

1. A core network system which performs bi-directional optical transmission, comprising:
a first transmission path for transmitting an optical signal, which is wavelength division-multiplexed, toward subscriber terminals from the core network; and
a second transmission path for transmitting an optical signal, which is wavelength division-multiplexed, from the subscriber terminals to the core network;
wherein transmission capacity of the second transmission path is lessen rather than transmission capacity of the first transmission path in agreement with asymmetry of traffic of the second transmission path to the first transmission path.

2. The core network system according to claim 1, wherein a contents holder is connected to the core network, and contents information is transmitted via the first transmission path toward the subscriber terminal from the contents holder.

3. The core network system according to claim 1, wherein transmission capacity of the second transmission path is set at 1/n (n is a value of two or more) of transmission capacity of the first transmission path.

4. The core network system according to claim 1, wherein transmission capacity of the second transmission path is made smaller than transmission capacity of the first transmission path by reducing a number of transmitted wavelengths on the second transmission path.

5. The core network system according to claim 4, wherein transmission capacity of the second transmission path is made smaller than transmission capacity of the first transmission path by using an electrical multiplexer, which performs electrical multiplexing of electric signals to be transmitted before electric/optical conversion, in the second transmission path.

6. The core network system according to claim 5, wherein the electrical multiplexer performs the electrical multiplexing by time-division multiplexing.

7. The core network system according to claim 5, wherein the electrical multiplexer performs the electrical multiplexing by a layer 2 multiplexing function.

8. The core network system according to claim 4, wherein transmission capacity of the second transmission path is made smaller than transmission capacity of the first transmission path by aggregating output ports to the second transmission path by an Layer 2 Switch which assigns a transmission route of the traffic, in the second transmission path.

9. The core network system according to claim 1, wherein transmission capacity of the second transmission path is made smaller than transmission capacity of the first transmission path by using a speed converter, which decelerates a transmission speed to the second transmission path, in the second transmission path.

10. The core network system according to claim 9, wherein the speed converter performs deceleration of a transmission speed by deleting an idle pattern within transmission signals.

11. Optical transmission equipment which constructs a core network system which performs bi-directional optical transmission, comprising:
a plurality of first transponders provided in a first transmission path for transmitting an optical signal, which is wavelength division-multiplexed, toward subscriber terminals from the core network; and
a plurality of second transponders provided in a second transmission path for transmitting an optical signal, which is wavelength division-multiplexed, from the subscriber terminals to the core network;
wherein transmission capacity of the second transmission path is smaller than transmission capacity of the first transmission path in agreement with asymmetry of traffic of the second transmission path to the first transmission path.

12. The optical transmission equipment according to claim 11, further comprising a switch which delivers a signal between the first and second transponders and the subscriber terminals.

13. The optical transmission equipment according to claim 11, wherein transmission capacity of the second transmission path is set at 1/n (n is a value of two or more) of transmission capacity of the first transmission path.

14. The optical transmission equipment according to claim 11, wherein transmission capacity of the second transmission path is made smaller than transmission capacity of the first transmission path by reducing a number of transmitted wavelengths to the second transmission path.

15. The optical transmission equipment according to claim 14, wherein the second transponder has an electrical multiplexer which performs electrical multiplexing of electric signals to be transmitted before electric/optical conversion, thereby reducing a number of transmitted wavelengths to the second transmission path is achieved.

16. The optical transmission equipment according to claim 15, wherein the electrical multiplexer performs the electrical multiplexing by time-division multiplexing.

17. The optical transmission equipment according to claim 15, wherein the electrical multiplexer performs the electrical multiplexing by a layer 2 multiplexing function.

18. The optical transmission equipment according to claim 12, wherein the switch is a Layer 2 Switch which assigns a transmission route of the traffic, and transmission capacity of the second transmission path is made smaller than transmission capacity of the first transmission path by the layer 2 switch aggregating output ports to the second transmission path.

19. The optical transmission equipment according to claim 11, wherein the second transponder has a speed converter which decelerates a transmission speed to the second transmission path, thereby transmission capacity of the second transmission path is made smaller than transmission capacity of the first transmission path by this.

20. The optical transmission equipment according to claim 19, wherein the speed converter performs deceleration of the transmission speed by deleting an idle pattern within transmission signals.

21. The optical transmission equipment according to claim 11, further comprising:
an optical demultiplexer which splits the optical signal wavelength division-multiplexed from the first transmission path and outputs it to the first transponders; and
an optical multiplexer which multiplexes optical signals from the second transponders and outputs the multiplexed signal to the second transmission path.

22. Optical transmission equipment which constructs a core network system which performs bi-directional optical transmission, comprising:
a plurality of first transponders provided in a first transmission path for transmitting an optical signal, which is wavelength division-multiplexed, toward subscriber terminals from the core network;
a plurality of second transponders provided in a second transmission path for transmitting an optical signal, which is wavelength division-multiplexed, from the subscriber terminals to the core network; and
means for lessening transmission capacity of the second transmission path rather than transmission capacity of the first transmission path in agreement with asymmetry of traffic of the second transmission path to the first transmission path.

23. Optical transmission equipment which constructs a core network system which performs bi-directional optical transmission, comprising:
a plurality of first transponders provided in a first transmission path for transmitting an optical signal, which is wavelength division-multiplexed, toward subscriber terminals from the core network; and
at least one second transponder provided in a second transmission path for transmitting an optical signal, which is wavelength division-multiplexed, from the subscriber terminals to the core network, and the number of the second transponder is smaller than that of the first transponders;
wherein the second transponder has an electrical multiplexer which performs electrical multiplexing of signals, which should be transmitted to the second transmission path, in a state of an electric signal, and an electric/optical converter which performs electric/optical conversion of the multiplexed electric signal; and
wherein transmission capacity of the second transmission path is smaller than transmission capacity of the first transmission path in agreement with asymmetry of traffic of the second transmission path to the first transmission path.

24. The optical transmission equipment according to claim 23, wherein the number of the second transponders is 1/n of the number of the first transponders (n is a value of two or more), and hence, transmission capacity of the second transmission path is 1/n of transmission capacity of the first transmission path.

25. Optical transmission equipment which constructs a core network system which performs bi-directional optical transmission, comprising:
a plurality of first transponders provided in a first transmission path for transmitting an optical signal, which is wavelength division-multiplexed, toward subscriber terminals from the core network;
at least one second transponder provided in a second transmission path for transmitting an optical signal, which is wavelength division-multiplexed, from the subscriber terminals to the core network, and the number of the second transponder is smaller than that of the first transponders; and
a switch provided between the first and second transponders and the subscriber terminals and assigns transmission routes of the traffic;
wherein the switch aggregates output ports to the second transponder in agreement with asymmetry of traffic of the second transmission path to the first transmission path, thereby transmission capacity of the second transmission path is smaller than transmission capacity of the first transmission path.

26. The optical transmission equipment according to claim 25, wherein the number of the second transponders is 1/n of the number of the first transponders (n is a value of two or more), and hence, transmission capacity of the second transmission path is 1/n of transmission capacity of the first transmission path.

27. Optical transmission equipment which constructs a core network system which performs bi-directional optical transmission, comprising:
a plurality of first transponders provided in a first transmission path for transmitting an optical signal, which is wavelength division-multiplexed, toward subscriber terminals from the core network; and
a plurality of second transponders provided in a second transmission path for transmitting an optical signal, which is wavelength division-multiplexed, from the subscriber terminals to the core network;
wherein the second transponder has a speed converter which decelerates a transmission speed of a signal, which should be transmitted to the second transmission path, in a state of an electric signal, and an electric/optical converter which performs electric/optical conversion of the speed-converted electric signal; and
wherein transmission capacity of the second transmission path is smaller than transmission capacity of the first transmission path in agreement with asymmetry of traffic of the second transmission path to the first transmission path.

28. A core network system which performs bi-directional optical transmission, comprising:
a first transmission path for transmitting an optical signal, which is wavelength division-multiplexed, toward subscriber terminals from the core network;
a second transmission path for transmitting an optical signal, which is wavelength division-multiplexed, from the subscriber terminals to the core network; and
means for lessening transmission capacity of the second transmission path rather than transmission capacity of the first transmission path in agreement with asymmetry of traffic of the second transmission path to the first transmission path.
